(19) United States
(12) Patent Application Publication
(10) Pub. No.: US 2015/0331951 A1
(43) Pub. Date: Nov. 19, 2015

(54) METHOD AND SERVER OF GROUP RECOMMENDATION

(71) Applicant: Tencent Technology (Shenzhen) Company Limited, Shenzhen (CN)

(72) Inventors: Xiaoyan Wang, Shenzhen (CN); Lifeng Sun, Shenzhen (CN)

(73) Assignee: TENCENT TECHNOLOGY (SHENZHEN) COMPANY LIMITED, Shenzhen (CN)

(21) Appl. No.: 14/807,457

(22) Filed: Jul. 23, 2015

Related U.S. Application Data
(63) Continuation of application No. PCT/CN2013/088759, filed on Dec. 6, 2013.

(30) Foreign Application Priority Data
Mar. 5, 2013 (CN) 201310069687.X

(51) Int. Cl. G06F 17/30

(52) U.S. Cl. CPC G06F 17/30867; G06F 17/30321; G06F 17/3053

(57) ABSTRACT

A method and server for recommending information to a group is provided, the method comprising obtaining a characteristic vector for each of a plurality of information items to be recommended to the group, wherein the characteristic vector comprises at least one characteristic; obtaining interest characteristics of a plurality of external users not in the group and having one-way correlation relationship with the group; and filtering the information items based on the interest characteristics of the external users, and recommending the retained information items to the group. The characteristics of external users outside the group are used to select information items to be recommended to the group, which enhances the efficacy of information recommendation.

### CROSS-REFERENCE TO RELATED APPLICATIONS

This application is a continuation of International Patent Application No. PCT/CN2013/088759, entitled “Method and Server of Group Recommendation,” filed on Dec. 6, 2013. This application claims the benefit and priority of Chinese Patent Application No. 201310069687.X, entitled “Method and Server of Group Recommendation” filed on Mar. 5, 2013. The entire disclosures of each of the above applications are incorporated herein by reference.

### TECHNICAL FIELD

The present invention relates to the internet, and more particularly, to a method and server for recommending information to groups.

### BACKGROUND

In the era of Web 2.0, large amount of social media information has been created due to the explosive growth of User Generated Content (UGC). Due to its social network root, social media information has great influence over user behaviors and consumer patterns. As the social media information is often shared by multiple users in social network groups, or recommended by the social network system, it significantly promotes user interaction in the social network.

Let's use video as an example. Rather than watching videos on the internet along, users tend to watch them in a group while sharing viewing experience. In a social network, there are a variety of groups, such as relatives, friends, classmates, colleagues, or even users of common contents, such as a common webpage. The size of the group varies as well, and can range from 3, 5, 8, to a much larger number. In the ear of Web 2.0, recommending videos that are of interest to all the users in a group is becoming increasingly important.

There are mainly two approaches in the existing methods of recommending videos to a group. The first approach, or the virtual user approach, is to virtualize the group into a virtual user, and make personalized recommendations to the virtual user. The second approach, or the characteristics merger approach, is to make personalized recommendations to each user in the group, and then consolidate the recommendations for the whole group. There are other approaches for recommending videos to a group, such as those taking into consideration the relationship among the users in the group, or the differences in interests among users in the group. However, all those approaches recommend videos based on the interests of users in the group, or the relationship among the users in the group.

Social network websites such as Twitter have made the concept of “follow” popular. As a result, it is now possible to have one-way relationship in a social network, i.e., A follows B, but B does not follow A. In addition, the interests of users outside the group who are being followed by the users in the group often accurately reflect the interests of the users in the group. The existing methods of recommending videos to groups only take into account the interests of users in the group and the relationship among the users in the group, and ignore the influence of users outside the group.

Thus, there is a need to provide a method and server of group recommendation to address the inefficacy in the prior art methods caused by ignoring the influences of users outside the group.

### SUMMARY OF THE INVENTION

The present invention provides a method and server for recommending information to a group to address the inefficacy in the prior art methods caused by ignoring the influences of users outside the group.

In accordance with embodiments of the present invention, a method for recommending information to a group is provided, the method comprising obtaining a characteristic vector for each of a plurality of information items to be recommended to the group, wherein the characteristic vector comprises at least one characteristic; obtaining interest characteristics of a plurality of external users not in the group and having one-way correlation relationship with the group; and filtering the information items based on the interest characteristics of the external users, and recommending the retained information items to the group.

In accordance with embodiments of the present invention, a server for recommending information to a group is provided, the server includes a characteristic vector module for obtaining a characteristic vector for each of a plurality of information items to be recommended to the group, wherein the characteristic vector comprises at least one characteristic; an interest characteristics module for obtaining interest characteristics of a plurality of external users not in the group and having one-way correlation relationship with the group; an information item filtering module for filtering the information items based on the interest characteristics of the external users; and an information item recommendation module for recommending the retained information items to the group.

In accordance with embodiments of the present invention, the characteristics of external users outside the group are used to select information items to be recommended to the group, which enhances the efficacy of information recommendation, particularly for groups with low activity level and weak internal relationship. Specifically, information items that are of interest to the group, but are not accessed by the group for various reasons, are recommended to the group, which enhances user experience and system efficiency.

### BRIEF DESCRIPTION OF THE DRAWINGS

To better illustrate the technical features of the embodiments of the present invention, various embodiments of the present invention will be briefly described in conjunction with the accompanying drawings.

FIG. 1 is an exemplary flowchart for a method for recommending information to a group in accordance with an embodiment of the present invention.

FIG. 2 is an exemplary flowchart for a method for recommending information to a group in accordance with an embodiment of the present invention.

FIG. 3 is an exemplary schematic diagram for a sever for recommending information to a group in accordance with an embodiment of the present invention.

### DESCRIPTION OF THE PREFERRED EMBODIMENTS

To better illustrate the purpose, technical feature, and advantages of the embodiments of the present invention, various embodiments of the present invention will be further described in conjunction with the accompanying drawings.

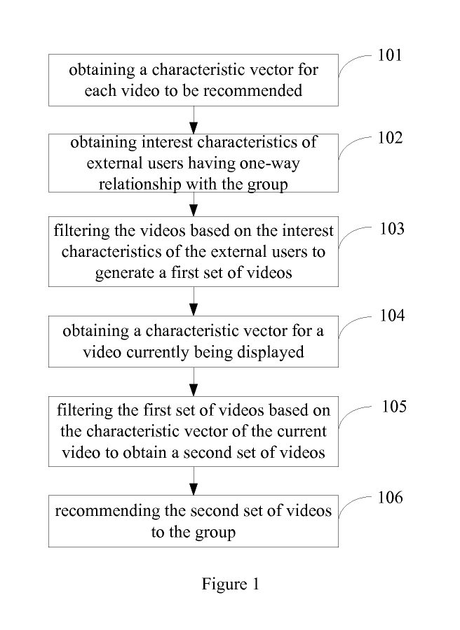

FIG. 1 is an exemplary flowchart for a method for recommending information to a group in accordance with an embodiment of the present invention. In the following description, video is used an example of information to be recommended to a group, but other information, such as multimedia information, images, or texts, can be used.

As shown in FIG. 1, the method for recommending information to a group includes the following steps.

Step 101: obtaining a characteristic vector for each video to be recommended to the group, wherein the characteristic vector comprises at least one characteristic.

Specifically, the videos to be recommended to the group are stored in a video database of the server, and the characteristic vector of video includes a number of, such as 10, characteristics of the video. These characteristics may include the title, label, or other description of the video, and may be obtained through linear discriminant analysis (LDA) or topic modeling of information regarding the video.

Step 102: obtaining interest characteristics of a plurality of external users not in the group and having one-way relationship with the group.

Specifically, the external users not in the group and having one-way relationship with the group can be external users not in the group who are followed by some users in the group, and do not follow any user in the group. In another words, there are two types of external users having relationship with the group: those who have one-way relationship with the group, i.e., those who are followed by some users in the group, and do not follow any user in the group; and those who have two-way relationship with the group, i.e., those who are followed by some users in the group, and follow some users in the group. For example, in Tencent Weibo, if a user within a group follows a user Liu Xiang outside the group, and Liu Xiang does not follow any user in the group, Liu Xiang is an external user having one-way relationship with the group.

It has been shown that the interests of users outside the group who are being followed by the users in the group often accurately reflect the interests of the users in the group, particularly if the external users do not follow any user in the group. Here, the interest characteristics of the external users are obtained to represent the interests of the external users. For example, the activities of the external users can be analyzed to obtain the videos followed by the external users, such as the video uploaded, watched, or commented by the external users; a characteristic vector for each video followed by the external users is then obtained, and the interest characteristics of the external users can be obtained by consolidating the characteristic vectors of the videos followed by the external users.

Step 103: filtering the videos based on the interest characteristics of the external users to generate a first set of videos to be recommended.

Specifically, a similarity index between the characteristic vector of each video and the interest characteristics of the external users is calculated, and the videos are filtered based on the similarity index. If the characteristic vector of a video has a high similarity with the interest characteristics of the external users, then it will be retained, and all the retained videos form a first set of videos to be recommended to the group. If the characteristic vector of a video has a low similarity with the interest characteristics of the external users, it will be removed.

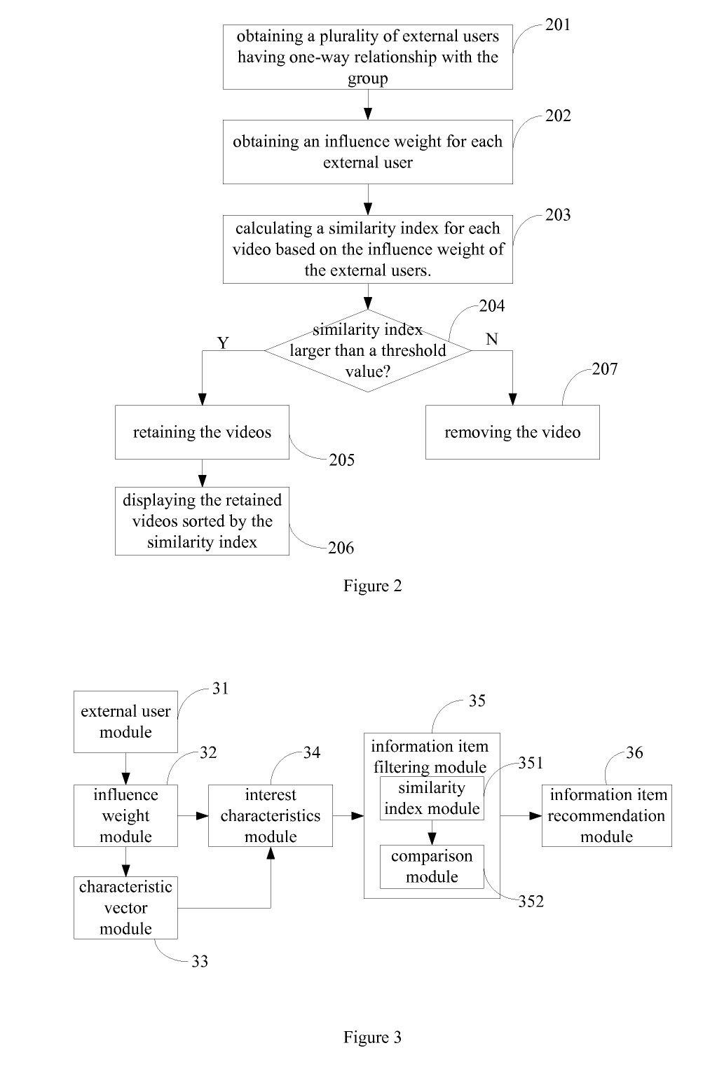

The interest characters of the external users and how to calculate the similarity index will be further described in connection with FIG. 2 below.

Step 104: obtaining a characteristic vector for a video currently being displayed.

Specifically, the video currently being displayed can be a video currently being displayed to the group, such as a video on the main page for the group. The characteristic vector of video includes a number of, such as 10, characteristics of the video. These characteristics may include the title, label, or other description of the video.

Step 105: filtering the first set of videos based on the characteristic vector of the video currently being displayed to obtain a second set of videos to be recommended.

Specifically, a similarity index between the characteristic vector of each video in the first set and the characteristic vector of the video currently being displayed is calculated, and the videos are filtered based on the similarity index. If the characteristic vector of a video has a high similarity with the characteristic vector of the video currently being displayed, then it will be retained, and all the retained videos form a second set of videos to be recommended to the group. If the characteristic vector of a video has a low similarity with the characteristic vector of the video currently being displayed, it will be removed. Thus, the recommendations are also context-based, which further enhances user experience.

Step 106: recommending the second set of videos to the group.

Specifically, the second set of videos can be displayed on the main page of the group. The videos can be sorted by the similarity index, and be displayed accordingly.

In accordance with this embodiment, videos to be recommended to the group are first filtered based on the interest characteristics of external users outside the group, and videos having a high similarity with the interest characteristic of the external users are retained to form a first set of videos to be recommended; the first set of videos are subsequently filtered based on the characteristic vector of the video currently being displayed, and videos having a high similarity with the video currently being displayed are retained to form a second set of videos to be recommended; and finally the second set of videos are recommended to the group.

In accordance with this embodiment, the interest characteristics of external users, such as experts, are obtained by analyzing the activities of the external users to represent the interests of the external users, and then used to select the videos to be recommended to the group, which enhances the efficacy of recommendation, particularly for groups with low activity level and weak internal relationship. Specifically, videos that are of interest to the group, but are not accessed by the group for various reasons, are recommended to the group, which enhances user experience and system efficiency. In addition, video current being displayed is further used to filter the videos to be recommended to provide context-based recommendations, which further enhances user experience and recommendation efficacy.

FIG. 2 is an exemplary flowchart for a method for recommending information to a group in accordance with another embodiment of the present invention. As shown in FIG. 2, the method for recommending information to a group includes the following steps.

Step 201: obtaining a plurality of external users not in the group and having one-way relationship with the group.

Step 202: obtaining an influence weight for each external user.

Specifically, the influence weight of the external user includes a following weight and a common behavior weight. The following weight is the number of following the external user has in the group. The common behavior weight is the ratio of the number of user activities in the group related to the external user to the number of total user activities in the group. In another words, the common behavior weight measures the percentage of activities in the group that was influenced by the external user.

In practice, the external users can be further divided into different user sets, and each user set may include one or more users. For example, the interest characteristics of the external users may be defined as preEx(G). The external users are divided into a number of user sets, and the interest characteristics may be defined as exPᵢ, and the influence weight of each user set may be defined as Wₑᵢ. When there is only one user in a particular user set, the influence weight of that user set is the influence set of that user. There is the following relationship between the interest characteristics of the external user sets and all the external users:

$$pre Ex ( G ) = \frac{{\sum }_{i = 1}^{n} {exP}_{i}^{*} {W}_{ei}}{{\sum }_{i = 1}^{n} {W}_{ei}} \qquad ( 1 )$$

Specifically, the interests of the external users can be obtained by analyzing the historical activities of the external users. For example, in Tencent Weibo, the historical activities of the external users are all the postings created or re-posted by the external users. In Twitter, the historical activities of the external users are all the tweeting and re-tweeting done by the external users. The historical activities of the external users are first analyzed to obtain the characteristics that the external users have expressed interests. Subsequently, the interest characteristic of the external users may be obtained through linear discriminant analysis (LDA) or topic modeling.

In accordance with this embodiment, the external users are divided into different user sets, and the interest characteristics of the external users are consolidated. For example, the external users may be divided into 15 different user sets through k-means clustering, such as sports stars, political analysts, et. al., and each user set has an influence weight indicating its level of influence to users in the group.

Step 203: calculating a similarity index between the characteristic vector of each information item and the interest characteristics of the external users based on the influence weight of the external users.

For example, a number of videos from a video library on the server is first preliminarily selected as videos to be recommended to the group. Linear discriminant analysis (LDA) or topic modeling can be conducted to obtain a characteristic vector for each video to be recommended, which may be represented as Vᵢ. The similarity index between a video and external users may be represented as simEx(G, i), and the interest characteristic of the external users may be represented as preEx(G). The relationship between the similarity index and the interest characteristic of the external users can be expressed as:

simEx(G,i)=Vᵢ×preEx(G) (2)

Specifically, the videos to be recommended to the group are stored in a video database of the server, and the characteristic vector of video includes a number of, such as 10, characteristics of the video. These characteristics may include the title, label, or other description of the video, and may be obtained through linear discriminant analysis (LDA) or topic modeling of information regarding the video.

Specifically, a similarity index between the characteristic vector of each video and the interest characteristics of the external users is calculated, and the videos are filtered based on the similarity index. If the characteristic vector of a video has a high similarity with the interest characteristics of the external users, then it will be retained, and all the retained videos form a first set of videos to be recommended to the group. If the characteristic vector of a video has a low similarity with the interest characteristics of the external users, it will be removed.

Step 204: comparing the similarity index of each video with a threshold value; if the similarity index is larger than the threshold value, proceeding to step 205; otherwise proceeding to step 207.

Step 205: retaining all videos whose similarity index is larger than the threshold value to forma first set of videos to be recommended.

Step 206: displaying the retained videos sorted by the similarity index.

Step 207: removing all videos whose similarity index is smaller than the threshold value.

For the video currently being displayed, its characteristic vector can be obtained by topic modeling. If the characteristic vector of the video currently being displayed is represented as P_{C}, the characteristic vector of the videos to be recommended is represented as Vᵢ, the similarity index between the video currently being displayed and the videos to be recommended is represented as sim(P_{C},Vᵢ), and the context-based filter factor is represented as then filter factor based on the video currently being displayed can be represented in the following equation:

flᵢ=sim(P_{C},Vᵢ) (3)

In accordance with this embodiment, the interest characteristics of the external users are obtained by analyzing the activities of the external users to represent the interests of the external users, and then used to select the videos to be recommended to the group, which enhances the efficacy of recommendation, particularly for groups with low activity level and weak internal relationship. Specifically, videos that are of interest to the group, but are not accessed by the group for various reasons, are recommended to the group, which enhances user experience and system efficiency. Experiences have shown that the recommendation effect of group recommendation method in accordance with this embodiment has far exceeded the existing methods known in the art, and has strong stability and reusability.

FIG. 3 is an exemplary schematic diagram for a server for recommending information to a group in accordance with an embodiment of the present invention.

As shown in FIG. 3, the server includes an external user module 31, an influence weight module 32, a characteristic vector module 33, an interest characteristics module 34, an information item filtering module 35, and an information item recommendation module 36 for recommending the retained information items to the group. The information item filtering module 35 includes a similarity index module 351 and a comparison module 352.

The external user module 31 is used to obtain external users not in the group and having one-way correlation relationship with the group. The influence weight module 32 is used for obtaining an influence weight for each external user. The influence weight of the external user includes a following weight and a common behavior weight, the following weight is the number of following the external has in the group, and the common behavior weight is the ratio of the number of user activities in the group related to the external user to the number of user activities in the group.

The characteristic vector module 33 is used for obtaining a characteristic vector for each of a plurality of information items to be recommended to the group, wherein the characteristic vector comprises at least one characteristic. The interest characteristics module 34 is used for obtaining interest characteristics of a plurality of external users not in the group and having one-way correlation relationship with the group.

The information item filtering module 35 is used for filtering the information items based on the interest characteristics of the external users.

Specifically, the similarity index module 351 in the information item filtering module 35 is used for calculating a similarity index between the characteristic vector of each information item and the interest characteristics of the external users. The comparison module 352 in the information item filtering module 35 is used for comparing the similarity index with a preset threshold value. The information item is retained if the similarity index is bigger than the threshold value.

The information item filtering module 35 is also used for filtering the information items based on interest characteristics of a plurality of external users to obtain a first set of information items to be recommended. The characteristic vector module 33 is also used for obtaining a characteristic vector for an information item currently being displayed currently being displayed. The information item filtering module 35 is used for filtering the first set of information items based on the characteristic vector of the information item currently being displayed to obtain a second set of information item to be recommended; and the information recommendation module 36 is used for recommending the second set of information items to the group. The similarity index module 351 in the information item filtering module 35 is also used for calculating a similarity index between the characteristic vector of each information item and the characteristic vector of the information item currently being displayed.

The information item recommendation module 36 is used for recommending information items retained by the information item filtering module 35 to the group. Preferably, the information item recommendation module 36 is further used for sorting information items retained by comparison module 352 based on the similarity index, and for recommending information items in the second set to the group.

The method for recommending information items to a group described above can be referenced for the operational principles of the various modules in the server.

In accordance with this embodiment, the interest characteristics of the external users are obtained by analyzing the activities of the external users to represent the interests of the external users, and then used to select the videos to be recommended to the group, which enhances the efficacy of recommendation, particularly for groups with low activity level and weak internal relationship. Specifically, videos that are of interest to the group, but are not accessed by the group for various reasons, are recommended to the group, which enhances user experience and system efficiency. Experiences have shown that the recommendation effect of group recommendation method in accordance with this embodiment has far exceeded the existing methods known in the art, and has strong stability and reusability.

The various embodiments of the present invention are merely preferred embodiments, and are not intended to limit the scope of the present invention, which includes any modification, equivalent, or improvement that does not depart from the spirit and principles of the present invention.

1. A method for recommending information to a group of users, the method comprising:
obtaining a characteristic vector for each of a plurality of information items to be recommended to the group, wherein the characteristic vector comprises at least one characteristic;
obtaining interest characteristics of a plurality of external users not in the group and having one-way correlation relationship with the group; and
filtering the information items based on the interest characteristics of the external users, and recommending the retained information items to the group.

2. The method of claim 1, wherein obtaining interest characteristics of a plurality of external users comprising:
obtaining a plurality of information items followed by the external users;
obtaining a characteristic vector for each of the plurality of information items followed by the external users; and
obtaining interest characteristics of the external users based on the characteristic vectors of the information items followed by the external users.

3. The method of claim 1, wherein filtering the information items based on the interest characteristics of the external users comprising:
calculating a similarity index between the characteristic vector of each information item and the interest characteristics of the external users; and
filtering the information items based on the similarity index.

4. The method of claim 3, further comprising:
setting a threshold value; and
filtering the information items to retain information items having a similarity index larger than the threshold value.

5. The method of claim 3, further comprising:
displaying the retained information items sorted by the similarity index.

6. The method of claim 1, further comprising:
filtering the information items based on interest characteristics of a plurality of external users to obtain a first set of information items to be recommended;
obtaining a characteristic vector for an information item currently being displayed currently being displayed;
filtering the first set of information items based on the characteristic vector of the information item currently being displayed to obtain a second set of information item to be recommended; and
recommending the second set of information items to the group.

7. The method of claim 6, wherein filtering the first set of information items based on the characteristic vector of the information item currently being displayed comprises:
calculating a similarity index between the characteristic vector of each information item in the first set of information items and the characteristic vector of the information item currently being displayed; and
filtering the plurality of information items based on the similarity index.

8. The method of claim 1, further comprising:
obtaining an influence weight for each external user;
wherein filtering the information items based on the interest characteristics of the external users comprises:
filtering the information items based on interest characteristics and the influence weight of each external user.

9. The method of claim 8, further comprising:
dividing the plurality of external users into a plurality external user sets; and
obtaining an influence weight for each external user set;
wherein filtering the information items based on the interest characteristics of the external users comprises:
filtering the information items based on interest characteristics and the influence weight of each external user set.

10. The method of claim 8, wherein the influence weight of the external user comprises a following weight and a common behavior weight, the following weight comprises the number of following the external has in the group, and the common behavior weight comprises a ratio of the number of user activities in the group related to the external user to the number of user activities in the group.

11. A server for recommending information to a group of users, the server comprising:
a characteristic vector module for obtaining a characteristic vector for each of a plurality of information items to be recommended to the group, wherein the characteristic vector comprises at least one characteristic;
an interest characteristics module for obtaining interest characteristics of a plurality of external users not in the group and having one-way correlation relationship with the group;
an information item filtering module for filtering the information items based on the interest characteristics of the external users; and
an information item recommendation module for recommending the retained information items to the group.

12. The server of claim 11, wherein the interest characteristics module is further configured for:
obtaining a plurality of information items followed by the external users;
obtaining a characteristic vector for each of the plurality of information items followed by the external users; and
obtaining interest characteristics of the external users based on the characteristic vectors of the information items followed by the external users.

13. The server of claim 11, wherein the information item filtering module further comprises:
a similarity index module for calculating a similarity index between the characteristic vector of an information item and the interest characteristics of the external users; and
a comparison module for comparing the similarity index with a preset threshold value.

14. The server of claim 13, wherein the information item filtering module is further configured for filtering the information items to retain information items having a similarity index larger than the threshold value.

15. The server of claim 13, where the information item recommendation module is further configured for:
displaying the retained information items sorted by the similarity index.

16. The server of claim 1, wherein the information item filtering module is configured for filtering the information items based on interest characteristics of a plurality of external users to obtain a first set of information items to be recommended;
the characteristic vector module is further configured for obtaining a characteristic vector for an information item currently being displayed currently being displayed;
the information item filtering module is further configured for filtering the first set of information items based on the characteristic vector of the information item currently being displayed to obtain a second set of information item to be recommended; and
the information recommendation module is further configured for recommending the second set of information items to the group.

17. The server of claim 16, wherein the similarity index module is configured for calculating a similarity index between the characteristic vector of each information item in the first set of information items and the characteristic vector of the information item currently being displayed.

18. The server of claim 11, further comprising an influence weight module for obtaining an influence weight for each external user; and
wherein the information item filtering module is further configured for filtering the information items based on interest characteristics and the influence weight of each external user.

19. The server of claim 18, wherein the influence weight module is further configured for dividing the plurality of external users into a plurality external user sets; and obtaining an influence weight for each external user set; and
wherein the information item filtering module is further configured for filtering the information items based on interest characteristics and the influence weight of each external user set.

20. The server of claim 18, wherein the influence weight of the external user comprises a following weight and a common behavior weight, the following weight comprises the number of following the external has in the group, and the common behavior weight comprises a ratio of the number of user activities in the group related to the external user to the number of user activities in the group.
